(19) United States
(12) Patent Application Publication
(10) Pub. No.: US 2018/0252244 A1
(43) Pub. Date: Sep. 6, 2018

(54) MCKIBBEN ARTIFICIAL MUSCLE

(71) Applicants: TOKYO INSTITUTE OF TECHNOLOGY, Tokyo (JP); NATIONAL UNIVERSITY CORPORATION OKAYAMA UNIV, Okayama (JP); KOGANEI CORPORATION, Tokyo (JP)

(72) Inventors: Koichi Suzumori, Tokyo (JP); Shukushi Seita, Okayama (JP); Shuichi Wakimoto, Okayama (JP); Kazutoshi Kouno, Tokyo (JP)

(73) Assignees: Tokyo Institute of Technology, Tokyo (JP); National University Corporation Okayama University, Okayama (JP); Koganei Corporation, Tokyo (JP)

(21) Appl. No.: 15/759,814

(22) PCT Filed: Jul. 8, 2016
(86) PCT No.: PCT/JP2016/070215

§ 371 Date: Mar. 13, 2018

(30) Foreign Application Priority Data
Sep. 14, 2015 (JP) 2015-180967

(51) Int. Cl. F15B 15/10

(52) U.S. Cl. CPC F15B 15/103

(57) ABSTRACT

A McKibben artificial muscle 1, that can be improved durability in an end portion, includes an elastic tube 10 and a braided tube 20. The elastic tube 10 is a hollow-and-cylindrical elastic body. The braided tube 20 that is constituted by circular-knitted threads with a predetermined knitting angle twisted over a periphery of the elastic tube 10 in a movable manner. The braided tube 20 has a contraction portion 21 and a restriction portion 22. The braided tube 20 in the contraction portion 21 is circularly-knitted with a knitting angle that enables the elastic tube to expand radially and contract in a length direction so as to obtain contraction force. The braided tube 20 in the restriction portion 22 is circularly-knitted with a knitting angle that suppresses radial expansion adjacent to an end portion 11 of the elastic tube 10.

### TECHNICAL FIELD

The present invention relates to a McKibben artificial muscle, and more particularly to a McKibben artificial muscle with improved durability in an end portion thereof.

### BACKGROUND ART

A McKibben artificial muscle is a fluid actuator drive artificial muscle, for example, an air cylinder, an artificial muscle, etc., which is driven by a change of fluid pressure. These muscles have a larger output against weight than electromagnetic actuators and the like. For example, a McKibben artificial muscle using air pressure is disclosed in Patent Document 1. The artificial muscle includes a hollow-and-cylindrical elastic tube, and a braided coated body for covering the elastic tube as a reinforcing layer. When the air is introduced into such a McKibben artificial muscle from a compressor, the elastic tubular body expands radially and contracts in the length direction, thereby producing contraction force.

In such a McKibben artificial muscle, an end portion is bonded with silicone adhesives or the like, or a dome-shaped cap is put on the end portion. An air supply tube is connected there to supply the air into the elastic tube via the end portion.

### PRIOR ART DOCUMENT

### Patent Document

Patent Document 1: Japanese Patent Application Kokai Publication No. Sho 48-24175

### SUMMARY OF THE INVENTION

### Problems to be Solved by the Invention

In the case of the conventional McKibben artificial muscle, since the artificial muscle steeply expands from their end portions radially, there is a risk that the artificial muscle strongly contacts with the peripheral portion of the silicone adhesive or the cap on the end portion, thereby the end portion is worn and damaged.

An object of the present invention, therefore, is to overcome the problems existing in the prior art, and to provide a McKibben artificial muscle with improved durability in an end portion.

### Means for Solving the Problems

To achieve the above object of the present invention, a McKibben artificial muscle according to the present invention that relaxes and contracts by fluid pressure, may include: an elastic tube that is a hollow-and-cylindrical elastic body; and a braided tube that is constituted by circularly-knitted threads with a predetermined knitting angle twisted over a periphery of the elastic tube in a movable manner, the braided tube having a contraction portion and a restriction portion, wherein the braided tube in the contraction portion is circularly-knitted with a knitting angle that enables the elastic tube to expand radially and contract in a length direction so as to obtain contraction force, and the braided tube in the restriction portion is circularly-knitted with a knitting angle that suppresses radial expansion adjacent to an end portion of the elastic tube.

The knitting angle that suppress radial expansion of the braided tube may be an equilibrium angle.

The braided tube may be circularly-knitted in such a way that the knitting angle gradually increases from the contraction portion toward the restriction portion.

The restriction portion may be used as an air supply tube that supplies air into the elastic tube.

The braided tube may have a marker for marking a portion of the restriction portion to be cut in a case where the contraction portion and the restriction portion are successively alternately provided.

### Advantages of the Invention

According to the present invention, the McKibben artificial muscle has the benefit of improving their end portions in durability.

### BRIEF DESCRIPTION OF THE DRAWINGS

FIGS. 1A and 1B are schematic side views for explaining a McKibben artificial muscle of the present invention, FIG. 1A showing a relaxation state and FIG. 1B showing a contraction state.

FIG. 2 is a partially enlarged schematic side view of an end portion of the McKibben artificial muscle of the present invention in a contraction state.

FIGS. 3A and 3B are schematic side views for explaining a case where an end portion of the McKibben artificial muscle of the present invention is constituted as an air supply tube, FIG. 3A showing a relaxation state and FIG. 3B showing a contraction state.

FIG. 4 is a schematic side view for explaining a case where an elastic tube and a braided tube of the McKibben artificial muscle of the present invention are successively provided.

### EMBODIMENTS FOR CARRYING OUT THE INVENTION

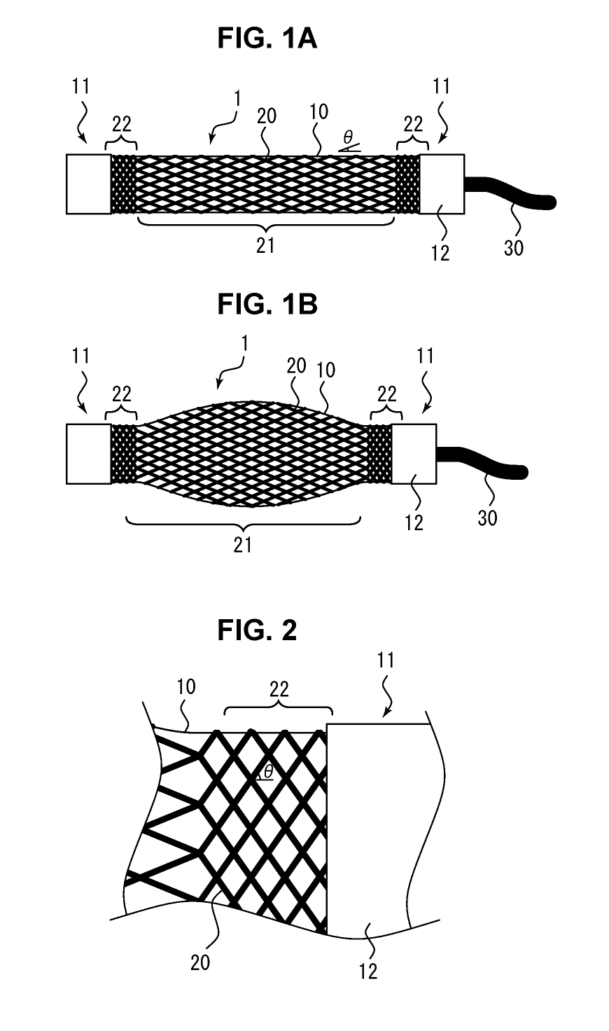

Hereinafter, an embodiment for practicing the present invention will be described with reference to the accompanying drawings. FIG. 1 is a schematic side view for explaining a McKibben artificial muscle according to the present invention, FIG. 1A showing a relaxation state and FIG. 1B showing a contraction state. As illustrated, a McKibben artificial muscle 1 of the present invention, which relaxes and contracts by fluid pressure, includes an elastic tube 10 and a braided tube 20. At an end portion 11 thereof, for example, a dome-shaped cap 12 may be placed, or silicone adhesives or the like are firmly fixed, or metal fittings for conveying a movement to other members or the like are attached. The fluid that is supplied into the elastic tube 10 is not limited to the air, but may be oil or other liquids.

The elastic tube 10 is a hollow-and-cylindrical elastic body. The air is supplied into its hollow via, for example, an air supply tube 30 from a compressor (not shown), A rubber tube, silicon tube or other materials used in a conventional McKibben artificial muscle, and also any other elastic bodies to be developed in the future may be applicable as the elastic body.

The braided tube 20 is constituted by circularly-knitted threads with a predetermined knitting angle of θ twisted over a peripery of the elastic tube 10 in a movable manner. More specifically, threads may be wound by, for example, a braiding machine in a spiral manner, and other threads may be reversely wound so as to cross the former, so that the braiding and knitting circularly may be carried out. The braided tube 20 may have a so-called pantograph structure, which can expand in the radial direction (or the direction perpendicular to its length direction) while contracting in the length direction. As shown in FIG. 1B, when the air is supplied from, for example, the compressor, the elastic tube 10 expands, but its movement is restricted by the braided tube 20. As a result, the elastic tube 10 contracts so as to be shorter in the length direction. It should be noted that the angle, number and pitch of the threads shown in the drawings are depicted solely for the purpose of explanation, and thus the present invention is not limited to the illustrated example.

The braided tube 20 includes a contraction portion 21 and a restriction portion 22, as shown in the drawings. In the contraction portion 21, the braided tube 20 is circularly-knitted with a knitting angle that enables the elastic tube 10 to expand radially and contract in a length direction so as to obtain contraction force. This angle may be a similar knitting angle of a braided tube used for a typical McKibben artificial muscle. For example, the knitting angle is between 15 and 30 degrees, or it is preferably; for example, 20 degrees. In the restriction portion 22, the braided tube 20 is circularly-knitted with a knitting angle that suppresses radial expansion adjacent to an end portion 11 of the elastic tube 10. The knitting angle in the restriction portion 22 may be larger than the knitting angle in the contraction portion 21. As for the knitting angle of the restriction portion 22, an equilibrium angle is the most effective for suppressing radial expansion, and that is about 55 degrees. Incidentally, the equilibrium angle is a knitting angle that allows the circularly-knitted braided tube 20 to achieve a mechanical equilibrium while causing no radial expansion or length-direction contraction in the elastic tube 10. Accordingly, the knitting angle in the restriction portion 22 is larger than that in the contraction portion and is appropriately adjusted within a range up to the equilibrium angle, depending on how much the radial expansion adjacent to the end portions 11 should be suppressed. Incidentally, an angle larger than the equilibrium angle has no effectiveness on how much the expansion is suppressed. Therefore, the upper limit of the range may be the equilibrium angle.

The braided tube 20 may be circularly-knitted so as to include the contraction portion 21 and the restriction portion 22 by controlling appropriately the rotation speed and winding speed of the bobbins of the braiding machine for knitting circularly.

FIG. 2 shows a partially enlarged schematic side view of the end portion of the McKibben artificial muscle of the present invention in a contraction state. In the drawing, the same reference numerals as those in FIG. 1 denote the same parts as those in FIG. 1. An area adjacent to the end portion 11 of the McKibben artificial muscle of the present invention is formed as the restriction portion 22 with the configuration described above. Accordingly, as illustrated, even when the McKibben artificial muscle is in the contraction state, the braided tube 20 and elastic tube 10 in the restriction portion 22 does not expand radially. Therefore, the peripheral portion of the dome-shaped cap 12 provided on the end portion 11 does not contact with the braided tube 20 or the elastic tube 10. This prevents the tube from fracturing and improves the durability of the end portion. This is also effective in preventing steep deformation of the end portion 11, and in preventing drop-off of the end portion 11 from the dome-shaped cap 12.

The contraction portion 21 and the restriction portion 22 of the McKibben artificial muscle of the present invention may be circularly-knitted in such a way as to allow a sharp change in its knitting angle θ. Instead, the braided tube may be circularly-knitted in such a way that the knitting angle gradually increases from the contraction portion 21 toward the restriction portion 22. For example, the knitting angle may be the smallest near the center in the longitudinal direction of the McKibben artificial muscle, and the knitting angle may gradually increase toward both the end portions. With this configuration, it is possible to prevent an excess unbalance in pressure resulting from a partial unbalance in an area where the knitting angle changes greatly.

Additionally, if the knitting angle of the braided tube is larger than the equilibrium angle, the McKibben artificial muscle contracts radially and expands in the length direction. For example, the contraction portion 21 may be configured with a knitting angle larger than such an equilibrium angle, and the restriction portion 22 may be configured with a knitting angle that suppresses a radial expansion. This configuration is capable of improving the durability of the end portion as well.

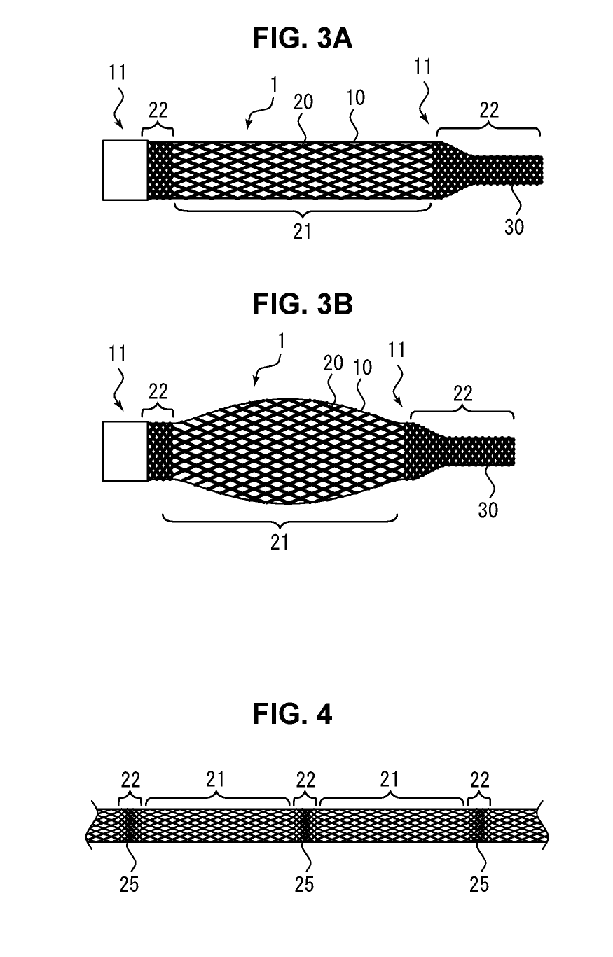

In the above-illustrated examples, the dome-shaped cap 12 is placed on the end portion 11, for example. However, the present invention is not limited to this. The braided tube 20 of the McKibben artificial muscle of the present invention has the restriction portion 22. The restriction portion 22 is circularly-knitted with a knitting angle that suppresses a radial expansion adjacent to the end portion 11. Accordingly, the restriction portion 22 is constituted to maintain the conditions of the elastic tube 10. Therefore, the restriction portion 22 can be used as an air supply tube that supplies air into the elastic tube 10. FIG. 3 is a schematic side view for explaining a case where the end portion of the McKibben artificial muscle of the present invention is constituted as an air supply tube. FIG. 3A shows a relaxation state and FIG. 3B shows a contraction state. In the drawing, the same reference numerals as those in FIG. 1 denote the same parts as those in FIG. 1, and their explanations are omitted.

As shown in the drawing, in this example, one of the end portions 11 of the McKibben artificial muscle is constituted as an air supply tube. A portion that is structured as the restriction portion 22 functions as the air supply tube. That is, the portion that is structured as the air supply tube has a larger knitting angle than the contraction portion 21, and may be circularly-knitted with, for example, the equilibrium angle. The end portion 11 with such a configuration may be used as the air supply tube and be connected to a compressor or the like.

According to the McKibben artificial muscle of the present invention, a dome-shaped cap or any similar parts are not required. Therefore, it makes the configuration simple.

Next, the explanation is for the case where the McKibben artificial muscles are manufactured by being cut into a predetermined length after the elastic tube 10 and the braided tube 20 of the McKibben artificial muscle of the present invention is formed successively. FIG. 4 is a schematic side view for explaining a case where the elastic tube and the braided tube of the McKibben artificial muscle of the present invention are successively provided. In the drawing, the same reference numerals as those in FIG. 1 denote the same parts as those in FIG. 1, and their explanations are omitted.

Generally, the McKibben artificial muscle is provided by circularly-knitting the braided tube on the elastic tube and is reeled up. Then, the string is cut into a predetermined length, and both the end portions are treated to make the McKibben artificial muscles. The McKibben artificial muscle of the present invention can similarly be made successively. However, a cut-off point may be at the portion of the restriction portion because the McKibben artificial muscle of the present invention has the contraction portion and the restriction portion. Providing a marker on the cut-off point at the portion of the restriction portion may be convenient.

Accordingly, the braided tube 20 of the McKibben artificial muscle of the present invention may have a marker 25 for marking a portion of the restriction portion 22 to be cut in the case where the contraction portion 21 and the restriction portion 22 are successively alternately provided. The marker 25 may be provided in such a way that the restriction portion 22 is colored by an ink-jet printer or the like built in the braiding machine for knitting circularly when the restriction portion 22 is circularly-knitted. Otherwise, the coloring may take place at the right time at the portion of the restriction portion 22 when the tube is reeled up after knitting circularly. Incidentally, the marker 25 is not limited to the coloring. A tape or the like, or any other means, may be applied, as long as it can make the cut-off point visible.

In this manner, according to the McKibben artificial muscle of the present invention, it is easy to understand where to cut off, even when the tube is manufactured successively.

The McKibben artificial muscle according to the present invention is not limited to the illustrated examples described above, but various modification may be made within the scope of the present invention. For example, a plurality of the McKibben artificial muscles of the present invention may be bundled together for use. Even in such a case, the durability can be improved because the movement of each of the elastic tubes of the end portions is restricted.

### EXPLANATION OF REFERENCE SYMBOLS

1: McKibben artificial muscle
10: Elastic tube
11: End portion
12: Dome-shaped cap
20: Braided tube
21: Contraction portion
22: Restriction portion
25: Marker
30: Air supply tube

1. A McKibben artificial muscle that relaxes and contracts by fluid pressure, the McKibben artificial muscle comprising:
an elastic tube that is a hollow-and-cylindrical elastic body; and
a braided tube that is constituted by circularly-knitted threads with a predetermined knitting angle twisted over a periphery of the elastic tube in a movable manner, the braided tube having a contraction portion and a restriction portion, wherein the braided tube in the contraction portion is circularly-knitted with a knitting angle that enables the elastic tube to expand radially and contract in a length direction so as to obtain contraction force, and the braided tube in the restriction portion is circularly-knitted with a knitting angle that suppresses radial expansion adjacent to an end portion of the elastic tube.

2. The McKibben artificial muscle according to claim 1, in which, the knitting angle that suppresses radial expansion of the braided tube is an equilibrium angle.

3. The McKibben artificial muscle according to claim 1, in which the braided tube is circularly-knitted in such a way that the knitting angle gradually increases from the contraction portion toward the restriction portion.

4. The McKibben artificial muscle according to claim 1, in which the restriction portion is used as an air supply tube that supplies air into the elastic tube.

5. The McKibben artificial muscle according to claim 1, in which the braided tube has a marker for marking a portion of the restriction portion to be cut in a case where the contraction portion and the restriction portion are successively alternately provided.
